(19) United States
(12) Patent Application Publication
(10) Pub. No.: US 2008/0283620 A1
(43) Pub. Date: Nov. 20, 2008

(54) Thermostatic mixer device for sanitary use

(76) Inventor: Alfons Knapp, Biberach (DE)

Correspondence Address: Delta Faucet Company c/o MASCO Corporation;Leon E. Redman, Esq., 21001 Van Born Road, Taylor, MI, 48180, US

(21) Appl. No.: 12/082,353

(22) Filed: Apr. 10, 2008

(30) Foreign Application Priority Data
May 17, 2007 (IT) TO 2007 A 000 351

(51) Int. Cl. G05D 23/13

(52) U.S. Cl. 236/12.16

(57) ABSTRACT

A thermostatic mixer device for sanitary use with a body, an inlet passage for hot water, an inlet passage for cold water, and a distribution passage for mixed water; a thermometric element installed partly within the distribution passage; a valve connected to the thermometric element and arranged so as to open or throttle, in a complementary fashion, the inlet passages, and a spring arranged so as to bias the valve; in which the spring is formed of a corrugated section. Illustratively, the spring is housed in an opening that extends peripherally around the distribution passage in which is installed the thermometric element, and this peripheral opening may constitute the internal portion of the inlet passage for the hot water.

### CROSS-REFERENCE TO RELATED APPLICATION

This application claims the benefit of Italian Patent Application No. TO 2007 A 000351, filed May 17, 2007, the disclosure of which is expressly incorporated by reference herein.

### BACKGROUND AND SUMMARY OF THE INVENTION

This invention relates to a thermostatic mixer device for sanitary use, featuring particular configurations intended to make sure that it will function correctly under various operating conditions.

To make sure that a thermostatic mixer device will work in the best possible fashion, it is necessary that, between the cold water and the hot water, fed to the mixer device, there will occur effective mixing before the water thus mixed laps or contacts the thermometric element that controls the operation of the thermostatic mixer device, and it is further necessary to make sure that this mixed water will flow in a regular and undisturbed fashion along the thermometric element. Although particular and sometimes complex configurations are adopted, the sanitary thermostatic mixer devices according to the state of the art work correctly when they have flowing through them standard rates of flow for which they are designed, but often they do not work correctly, and they can present phenomena of instability, when they have running through them a greatly reduced flow rate on account of the presence of resistances down the line from the thermostatic device, such as, for example, aerators, spouts, shower heads, and the like.

Disorders in the operation of thermostatic mixer devices for sanitary use in particular may be due to the presence, in proximity of the thermometric element, of springs that are necessary to bias a valve which is controlled by the thermometric element and that causes the opening or closing of the inlet openings for hot water and for cold water, so as—while mixing the hot water and the cold water—to generate a flow of mixed water that has the prescribed temperature. These springs, which usually are helicoidal springs, typically have a considerable length so as to offer sufficient uniformity and stability, and because of their shape and their dimensions, they may intensely disturb the flow of mixed water that laps or contacts the thermometric element. Although these springs are typically housed in openings that are only adjacent to the delivery passage but through which there is no mixed water flow directly, they are nevertheless lapped or contacted by said flow and may cause damaging turbulences in it.

In view of the above, it is desired to provide an arrangement that will be suitable in preventing disturbances in the flow of mixed water caused by the biasing springs of the thermostatic device valve.

According to an illustrative embodiment of the invention, the usual helicoidal springs are replaced with special springs with corrugated section pieces, which are known in technology but which are not known to have been used in thermostatic mixer devices for sanitary use.

According to an illustrative embodiment of the invention, a thermostatic mixer device for sanitary use includes a body with an inlet passage for hot water, an inlet passage for cold water, and a distribution passage for mixed water. A thermometric element is installed partly inside the distribution passage. A valve is arranged to open or throttle, in a complementary fashion, the inlet passages, this valve being connected to the thermometric element, by which it is controlled. A spring is arranged so as to bias said valve in a direction opposite to the action of the thermometric element, characterized primarily in that the spring includes an undulating or corrugated section.

Illustratively, the spring is housed in an opening that extends peripherally around the distribution passage in which is installed the thermometric element.

Further illustratively, the peripheral opening constitutes the internal portion of the inlet passage for the cold water or for the hot water.

As a result of these arrangements, the disturbance caused to the flow of mixed water by the presence of the spring becomes negligible, first of all, by virtue of the fact that a spring of the kind considered has an extent that is extremely reduced in terms of length, and, secondly, because such a spring is configured to be housed in a very small opening and is situated in such a position as to minimize the disturbance to the mixed water flow, an opening which, in the illustrative embodiment, is the one that is placed there for the introduction of the hot water flow that is conveyed to the mixing action.

Springs including corrugated sections are characterized by great uniformity and stability in terms of their elastic characteristics, these being characteristics that are difficult to implement in helicoidal springs even though they may be quite long.

It should be appreciated that the use of conventional helicoidal springs entails greater complexity or difficulty in designing the parts of the thermostatic mixture device. On the other hand, the spring of the present disclosure makes it possible to simplify the structure and facilitate the design and construction of the thermostatic mixture device.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, purposes and advantages of the object of this invention will appear more clearly from the following description of illustrative embodiments, constituting nonrestrictive examples, with reference to the attached drawings where:

FIG. 1 illustrates a diametrical section of a thermostatic mixer device featuring the characteristic configurations according to a first illustrative embodiment.

FIG. 2 illustrates a diametrical section of a thermostatic mixer device featuring the characteristic configurations according to a second illustrative embodiment.

FIGS. 3 to 7 illustrate configurations of the undulating sheet that constitutes the spring employed according to various illustrative embodiments.

### DETAILED DESCRIPTION OF THE DRAWINGS

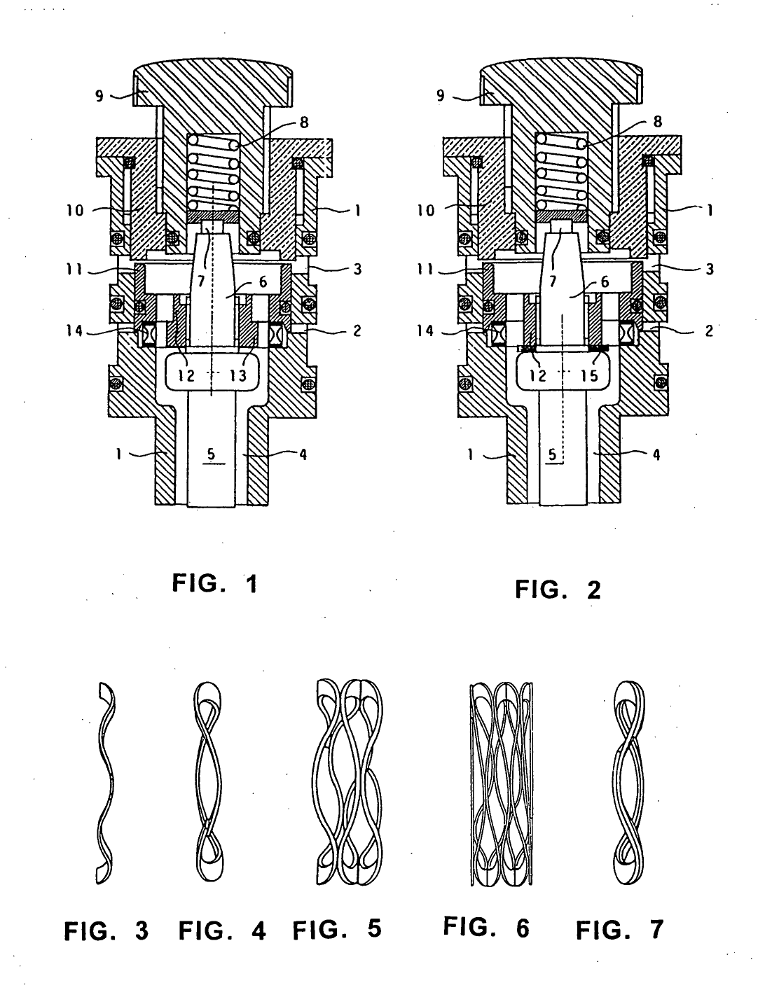

FIG. 1 illustrates a thermostatic mixer device that comprises a body 1 with a hot water inlet passage 2 for hot water, a cold water inlet passage 3 for cold water, and a mixed water distribution passage 4 for the distribution of mixed water at a regulated temperature. In passage 4, for the distribution of mixed water, there is installed the temperature sensitive bulb 5 of a thermometric element 6 whose mobile shaft 7 rests—via a safety spring 8—against the regulating member 9, screwed into a plug 10, which occludes the body 1 at its end opposite the distribution passage 4.

Inside body 1 there is housed a valve 11 that is connected with a central portion 12 to the thermometric element 6 which—when it is dilated or expanded on account of an increase in the temperature of the mixed water—propels valve 11 toward inlet passage 2 for the hot water, which is thus divided. The spring 14 is needed here for the purpose of biasing the valve 11 in the direction—opposite to the former—of the division of inlet passage 3 for cold water. According to an illustrative embodiment, this spring 14 consists of a corrugated elastic metallic section piece, illustratively formed of steel, which is housed in a peripheral opening that radially surrounds the distribution passage 4, and it operates between body 1 and valve 11, biasing the latter toward inlet passage 3 for the cold water.

Considering the features of this type of spring, the peripheral opening, containing spring 14, has very modest dimensions and, in particular, it extends a rather nominal amount in the direction of the axis of the device, so that the presence of the spring will not cause appreciable disturbance in the flow of the mixed water. Furthermore, the peripheral wall of the distribution passage 4 can be arranged in close vicinity to bulb 5 of the thermometric element 6, thus ensuring a close adherence of the mixed water flow that laps or contacts bulb 5 and a regular rate of said undisturbed flow.

In the illustrative form shown, the opening that contains spring 14, is an internal ring-shaped portion of inlet passage 2 for hot water, which thus passes through spring 14. As a result of this arrangement, one can greatly rationalize the structure of the thermostatic mixture device.

Illustratively, the central portion 12 of valve 11, which is connected to the thermometric element 6, expands toward bulb 5, up to a diameter that almost corresponds to the adjacent portion of bulb 5, so as to give the distribution paths 4 a particularly regular configuration.

The embodiment according to FIG. 2 differs from the form just described only by way of the configuration of the central portion 12 of valve 11, which does not present the extended part 13, which is replaced, in terms of its function, by a ring 15 inserted between valve 11 and bulb 5 of thermometric element 6. This configuration may, in certain cases, be preferable. However, in certain cases ring 15 may also be omitted.

In the two embodiments described, spring 14 is arranged in a peripheral opening, constituting the internal ring-shaped portion of inlet passage 2 for the hot water. It should however be understood that the opening that contains the spring 14 may be arranged in a different position where this would turn out to be opportune for construction reasons. Furthermore, the use of the type of the spring considered may turn out to be advantageous also in connection with arrangements where the spring itself is not in contact with the mixed water flow.

Springs made up of an undulating section piece are known, but are hardly familiar and so far have not been known to be used in thermostatic mixer devices for sanitary use. These springs are made in various illustrative configurations, some of which are shown in FIGS. 3 to 7. Naturally, when it comes to employment according to above detailed embodiments, the spring 14 must be made in a ring-shaped or annular form.

Although the invention has been described in detail with reference to certain preferred embodiments, variations and modifications exist within the spirit and scope of the invention as described and defined in the following claims.

1. A thermostatic mixer device for sanitary use comprising a body with an inlet passage for hot water, an inlet passage for cold water, and a distribution passage for mixed water; a thermometric element installed partly inside said distribution passage; a valve arranged so as to open or throttle, in a complementary fashion, said inlet passages, said valve being connected to the thermometric element by which it is controlled; and a spring arranged to bias said valve in a direction opposite to the action of said thermometric element; characterized in that said spring includes a corrugated section.

2. The thermostatic mixer device according to claim 1, characterized in that said spring is housed in an opening that extends peripherally around said distribution passage in which is installed said thermometric element.

3. The thermostatic mixer device according to claim 2, characterized in that said peripheral opening comprises an internal portion of said inlet passage for the cold water.

4. The thermostatic mixer device according to claim 2, characterized in that said peripheral opening comprises an internal portion of said inlet passage for the hot water.

5. The thermostatic mixer device according to claim 1, characterized in that said valve has a central portion which is linked to said thermometric element and which expands toward a bulb of said thermometric element, up to a diameter that closely corresponds to the adjacent portion of said bulb itself.

6. The thermostatic mixer device according to claim 1, characterized in that a ring is inserted between said valve, linked to said thermometric element, and a bulb of the thermometric element.

7. The thermostatic mixer according to claim 1, wherein said corrugated section of said spring is formed of steel.

8. A thermostatic mixer device comprising:
a body including a hot water inlet passage, a cold water inlet passage, and a mixed water distribution passage in fluid communication with said hot water inlet passage and said cold water inlet passage;
a thermostatic element at least partially received within said mixed water distribution passage;
a valve movably received within said body and operably coupled to said thermometric element to control water flow through said hot water inlet passage and said cold water inlet passage; and
a spring received within an opening extending peripherally around said distribution passage and operably coupled to said valve, said spring being configured to bias said valve in a direction opposite to the action of said thermometric element, said spring including a corrugated section.

9. The thermostatic mixer device of claim 8, wherein said corrugated section of said spring is formed of metal.

10. The thermostatic mixer device of claim 8, wherein said peripheral opening comprises an internal portion of said cold water inlet passage.

11. The thermostatic mixer device of claim 8, wherein said peripheral opening comprises an internal portion of said hot water inlet passage.

12. The thermostatic mixer device of claim 8, characterized in that said valve has a central portion which is linked to said thermometric element and which expands toward a bulb of said thermometric element, up to a diameter that closely corresponds to the adjacent portion of said bulb itself.

13. The thermostatic mixer device of claim 8, characterized in that a ring is inserted between said valve, linked to said thermometric element, and a bulb of the thermometric element.

14. The thermostatic mixer device of claim 8, wherein said corrugated section of said spring includes a ring having a plurality of undulations.
